(19) United States
(12) Patent Application Publication
(10) Pub. No.: US 2007/0012263 A1
(43) Pub. Date: Jan. 18, 2007

(54) Dog marking prevention garment

(76) Inventor: Lisa Hammonds, Alto, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/181,295

(22) Filed: Jul. 14, 2005

(51) Int. Cl. A01K 13/00

(52) U.S. Cl. 119/850

(57) ABSTRACT

A dog marking prevention garment having a pant made of non-waterproof material, and having an upper cross strap detachably secured to the pant waistband and the upper cross strap extending from said waist band to the collar. Also a lower linear strap is detachably secured to the pant waistband, and the lower linear strap extending from said waist band to the collar.

### BACKGROUND OF THE INVENTION

This invention relates to a garment worn by dogs to prevent them from “marking.”

U.S. Pat. No. 6,142,105 discloses a pet diaper constructed of top, bottom, and side panels 18, 20, 22, and 44, which are preferably made of water proof material. See column 3, lines 3842. The '105 patent further discloses that the top, bottom, and panels 18, 20, 22, 24 are preferably made of Tyvek® or other polymeric fabric-like materials. The diaper top, side, and panels 18, 20, 22, and 24 have suspenders 28 extending forwardly and the suspenders are described as “ . . . adapted to engage the shoulder areas of the animal . . . ” (column 4, lines 12-13). FIG. 2 shows the suspenders 28 contacting the shoulders of the dog, and extending underneath the dog's arms, and extending rearwardly to a diaper belt 30, that has belt loops 32.

U.S. Pat. No. 6,675,745 discloses a pet diaper 10 having an absorbent garment 20. This garment is designed to wrap around a substantial portion, or entire portion of the dog's underside as illustrated in FIG. 4.

On an annual basis thousands of dogs are surrendered to animal shelters, or euthanized because of the innate behavior of marking indoors. Marking is a method used by dogs to lay claim to territory. This is more common with male dogs than females. Unless a dog is neutered or spayed before around six (6) months of age, territorial marking, once established, is virtually impossible to reverse or correct.

In addition to behavioral differences, marking is different from common urination problems or incontinence. In marking, the dog releases a squirt of urine, rather than a stream. Marking is intentional, and the target or marking area specific. Conversely incontinence is an illness that causes a dog to urinate in a location that it may not wish to, but it simply has no control. Thus the stream of urine may be substantial as compared with the short squirts of marking.

The prior art consists of diapers to prevent leaking of urination or feces. Thus they are usually waterproof, bulky, and they trap body heat, making the animal hot and uncomfortable. Because marking is less than 50%-wt urine compared with a urination event, the prior art does not address a solution for resolving this lower volume urine amount.

As can be seen, there is a need for a garment that can be worn by a dog, to specifically prevent marking problems.

### SUMMARY OF THE INVENTION

An aspect of the present invention is a dog marking prevention garment for a dog having a collar, comprising: a pant having a tail aperture, a leg aperture, a waist band, and a waist aperture, said pant made of non-waterproof material; an upper cross strap extending from said waist band to the collar, said upper cross strap having an intersection disposed rearwardly of the collar, said upper cross strap disposed to extend along the back of the dog, said upper cross strap having a rear-upper cross strap connector to adjustably detachably secure said upper cross strap to at least one of said pant or waistband, said upper cross strap having a front-upper cross strap connector to secure said front upper cross strap to the collar; and a lower linear strap extending from said waist band to the collar, said lower linear strap disposed at about the lowest point on at least one of said pant or said waistband, and extending to about the lowest point on the collar, said lower linear strap having a rear-lower linear connector to adjustably detachably secure said lower linear strap to said pant, said lower linear strap having a front lower linear connector to detachably secure said lower linear strap to the collar.

Another aspect of the present invention is a dog marking prevention garment for a dog having a collar, comprising: a pant having a tail aperture, a leg aperture, a waist band, and a waist aperture, said pant made of non-waterproof material; an upper cross strap extending from said waist band to the collar, said upper cross strap having an intersection disposed rearwardly of the collar, said upper cross strap disposed to extend along the back of the dog, said upper cross strap having a rear-upper cross strap connector to adjustably detachably secure said upper cross strap to at least one of said pant or waistband at a point, each of said points being separated by an angle of 75 degrees or greater, said upper cross strap having a front-upper cross strap connector to secure said front upper cross strap to the collar; and a lower linear strap extending from said waist band to the collar, said lower linear strap disposed at about the lowest point on at least one of said pant or said waistband, and extending to about the lowest point on the collar, said lower linear strap having a rear-lower linear connector to adjustably detachably secure said lower linear strap to said pant, said lower linear strap having a front lower linear connector to detachably secure said lower linear strap to the collar.

An object of the present invention is to simply create an ample, absorbent barrier between the dog's genitalia and the object or target of the dog's spray.

These and other features, aspects and advantages of the present invention will become better understood with reference to the following drawings, description and claims.

### BRIEF DESCRIPTION OF THE DRAWINGS

FIG. 1 is a pictorial of a side view of the present invention;

FIG. 2 is a pictorial of a top view of the present invention; and

FIG. 3 is a pictorial of a bottom view of the present invention.

FIG. 4 is a schematic of the waistband and cross strap intersection points.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

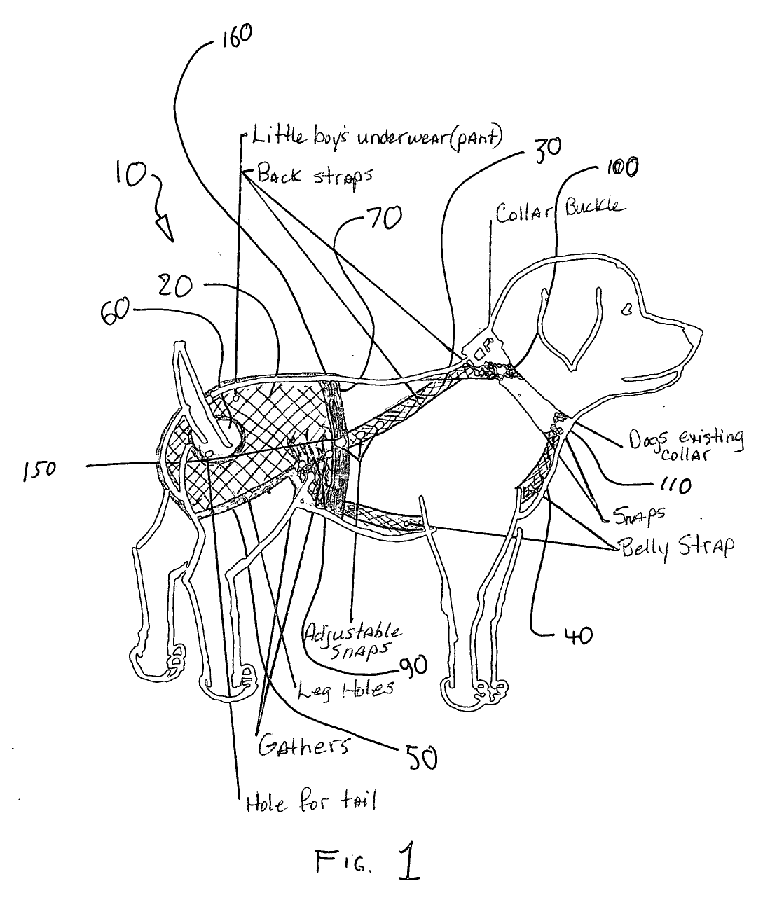

FIG. 1 illustrates the dog marking prevention garment 10. The garment has a pant 20 having a leg aperture 50, and a waist aperture 70. IN an exemplary embodiment, there are two leg apertures, one for each leg of a dog with two rear legs. The pant 20 is comprised of a cotton or cotton-like material having non-water-proof properties. This is because the present invention is for dogs that are attempting to mark, or spray a small amount of urine. The more common pet diaper of the prior art is designed for incontinence problems, so they teach the use of diapers possessing water-proof properties, which are inappropriate for the uses and practices of the present invention. The present invention, being cotton, is a breathable garment, lightweight, and is does not alter the dog's core temperature, as may a water-proof diaper. In an exemplary embodiment the pant 20 has a double cotton, or double fabric layer adjacent the genitalia or in the crotch part of the pant 20. This double layer is not necessary near the waist aperture 70. The pant 20 has sewn in gathers 90 adjacent the tail aperture 60 and the leg aperture 50 to aid in retaining the pant 20 in place.

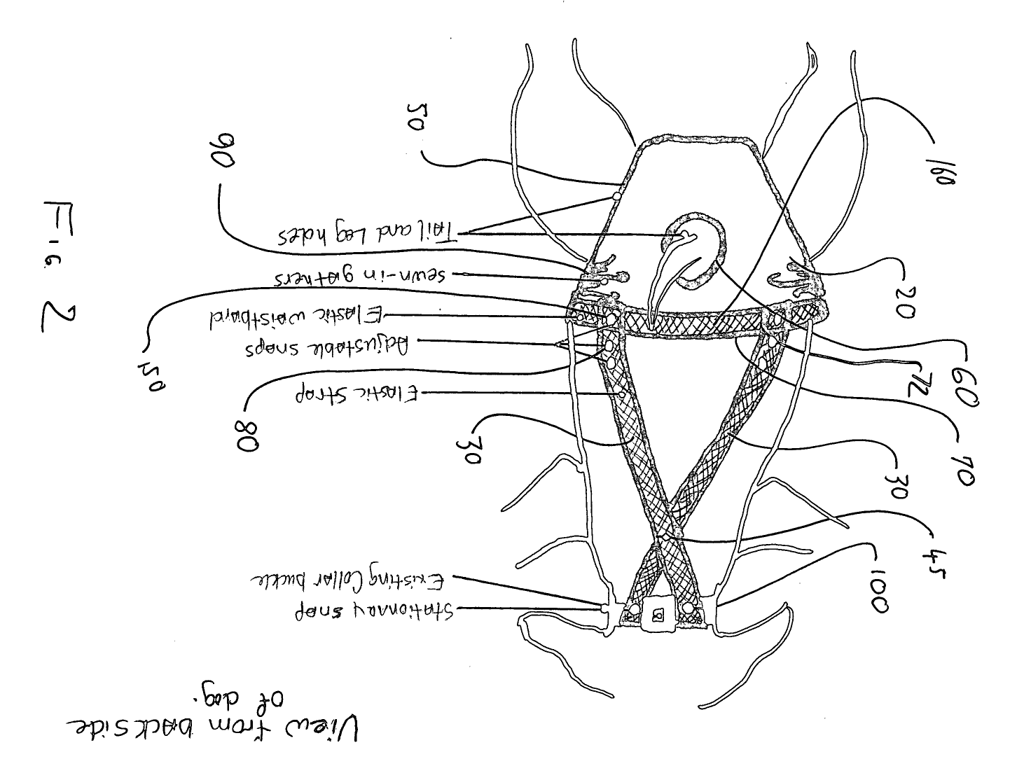

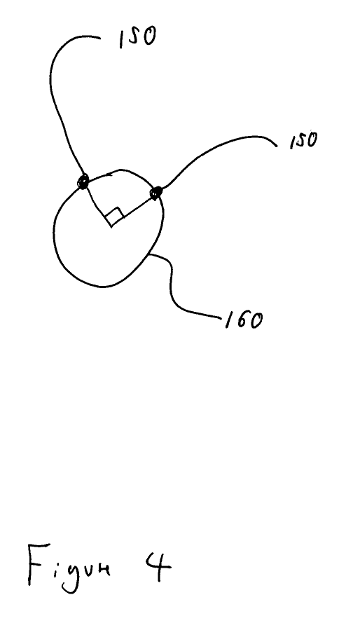

As illustrated in FIGS. 1 and 2, each cross strap 30 intersects with the waistband 160 at a point 150. In one exemplary embodiment of the invention, the points 150 may be 90 degrees apart (as seen in FIG. 4). In a further exemplary embodiment, the points 150 are greater than 90 degrees apart.

As illustrated in FIG. 2, the pant 20 is secured to the dog by two upper-cross straps 30, that cross at an intersection 45 disposed just behind the collar around the neck of the dog—on the back or upper side of the neck; or the intersection 45 may be disposed behind a buckle of the dog's existing collar. The straps 30 and the waist aperture 70 have rear-upper cross strap connectors 80 disposed near the waist aperture 70 that can connect a rear portion of the cross strap 30 to the waist aperture 70. The rear-upper cross strap connectors 80 are adjustable so as to change the distance from the waist aperture 70 with respect to; for example, the dog's existing collar so as to accommodate for different sized dogs. The rear-upper cross strap connectors 80 may be snaps (one part on the strap 30—the other on or near the waist band 72), buttons (one button on the strap-the button hole on the waist band), or Velcro®.

The straps 30 connect to the collar of the dog via a front-upper cross strap connector 100. Each strap 30 has its respective front-upper cross strap connector 100 disposed away from the other, and secured to the dog's existing collar. This feature assists the dog in accepting the garment 10 because the dog can still wear its own collar—there is no new contraption around the dog's neck, to secure the garment 10 to the dog.

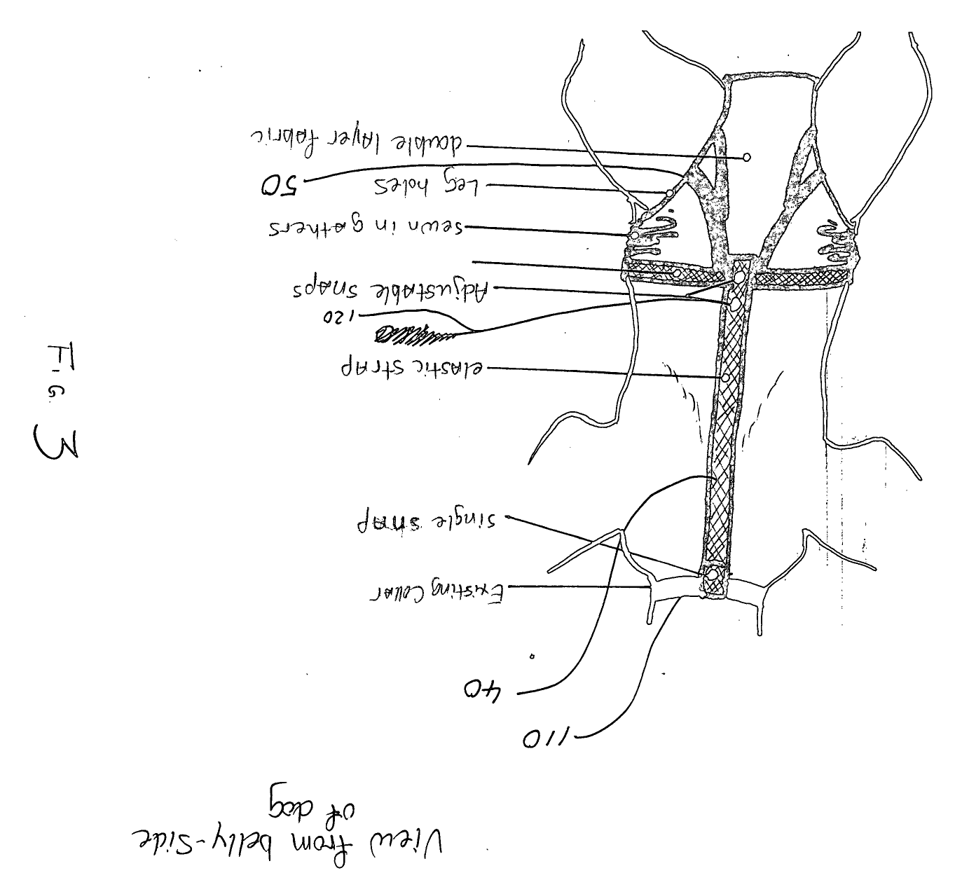

As illustrated in FIG. 3, a lower linear strap 40 connects the pant 20 relative to the dog collar. A front-lower linear connector 110 secures the lower-linear strap 40 to the collar by a front-lower linear connector 110. The front-lower linear connector 110 may be constructed as the front-upper cross strap connector 100. A rear-lower linear connector 120 adjustably detachably secures the lower linear strap 40 to the pant 20. The rear-lower linear connector 120 can adjustably detachably connect to the pant 20 or waistband 72 as does the rear-upper cross strap connector 80, such as by a variety of apparatus or principles, such as buttons, snaps, Velcro®, or even magnets.

To use the present invention, the garment 10 can be applied to the dog when inside a residence and while in the supervision of humans, or for short periods of time. As the present invention is not designed to receive feces or urination to relieve a dog bladder, beyond that of marking.

One aspect of the design is the straps 30, 40 extending from the pant 20 to the collar. In one exemplary, the straps 30, 40 are elastic. The straps 30, 40 are to be taught but not uncomfortably tight so that the dog's genitalia do not “pop” out in everyday moments.

Because of the way that the upper cross straps 40 connect to the collar, it is required that the dog collar have a collar. In a further exemplary embodiment the upper cross straps 40 connect to the collar on opposed side of a buckle, and adjacent to the buckle. The upper-cross straps 40 are secured to the collar.

Once a good fit has been established, any excess material from the strap 30, 40 can be cut off if desired, or left as is. The strap running from the underside of the dog, from the pant to the collar, is adjustable with the likes of snaps on the outside of the pant so as not to irritate the dog's genitalia The present invention does not require the changing of pads or purchasing diaper liners. It is simply laundered and ready to wear again. Also, will less padding and bulk in the pant and no elastic around the tail or legs, as compared with the prior art, the present invention allows for greater mobility and comfort for the dog.

It should be understood, of course, that the foregoing relates to exemplary embodiments of the invention and that modifications may be made without departing from the spirit and scope of the invention as set forth in the following claims.

I claim:

1. A dog marking prevention garment for a dog having a collar, comprising:
a pant having a tail aperture, a leg aperture, a waist band, and a waist aperture, said pant made of non-waterproof material;
an upper cross strap extending from said waist band to the collar, said upper cross strap having an intersection disposed rearwardly of the collar, said upper cross strap disposed to extend along the back of the dog, said upper cross strap having a rear-upper cross strap connector to adjustably detachably secure said upper cross strap to at least one of said pant or waistband, said upper cross strap having a front-upper cross strap connector to secure said front upper cross strap to the collar; and
a lower linear strap extending from said waist band to the collar, said lower linear strap disposed at about the lowest point on at least one of said pant or said waistband, and extending to about the lowest point on the collar, said lower linear strap having a rear-lower linear connector to adjustably detachably secure said lower linear strap to said pant, said lower linear strap having a front lower linear connector to detachably secure said lower linear strap to the collar.

2. The garment of claim 1, wherein said pant has a double layer of material in at least one portion disposed between said leg apertures.

3. The garment of claim 1, wherein gathers are sewn in and disposed so as to biasly reduce the diameter of said leg aperture.

4. The garment of claim 1, wherein gathers are sewn in and disposed so as to biasly reduce the diameter of said tail aperture.

5. The garment of claim 1, wherein said rear-upper cross strap connectors are snaps, with one portion of the snap disposed on said rear-upper cross strap, and said snap has another portion on said pant near or at said waist band.

6. The garment of claim 1, wherein said rear-lower linear connector is a snap, said snap having one portion fixed to said lower linear strap, and said snap having a second portion fixed to said pant.

7. The garment of claim 1, wherein at least one of said upper cross strap, said lower linear strap, or said waistband has elastic properties.

8. The garment of claim 1, further comprising a point defined by the intersection of the upper cross strap with the waistband, and each point separated by 90 degrees.

9. The garment of claim 1, further comprising a point defined by the intersection of the upper cross strap with the waistband, and each point separated by greater than 90 degrees.

10. A dog marking prevention garment for a dog having a collar, comprising:
a pant having a tail aperture, a leg aperture, a waist band, and a waist aperture, said pant made of non-waterproof material;
an upper cross strap extending from said waist band to the collar, said upper cross strap having an intersection disposed rearwardly of the collar, said upper cross strap disposed to extend along the back of the dog, said upper cross strap having a rear-upper cross strap connector to adjustably detachably secure said upper cross strap to at least one of said pant or waistband at a point, each of said points being separated by an angle of 75 degrees or greater, said upper cross strap having a front-upper cross strap connector to secure said front upper cross strap to the collar; and
a lower linear strap extending from said waist band to the collar, said lower linear strap disposed at about the lowest point on at least one of said pant or said waistband, and extending to about the lowest point on the collar, said lower linear strap having a rear-lower linear connector to adjustably detachably secure said lower linear strap to said pant, said lower linear strap having a front lower linear connector to detachably secure said lower linear strap to the collar.

11. The garment of claim 8, wherein said pant has a double layer of material in at least one portion disposed between said leg apertures.

12. The garment of claim 8, wherein gathers are sewn in and disposed so as to biasly reduce the diameter of said leg aperture.

13. The garment of claim 8, wherein gathers are sewn in and disposed so as to biasly reduce the diameter of said tail aperture.

14. The garment of claim 8, wherein said rear-upper cross strap connectors are snaps, with one portion of the snap disposed on said rear-upper cross strap, and said snap has another portion on said pant near or at said waist band.

15. The garment of claim 8, wherein said rear-lower linear connector is a snap, said snap having one portion fixed to said lower linear strap, and said snap having a second portion fixed to said pant.

16. The garment of claim 8, wherein at least one of said upper cross strap, said lower linear strap, or said waistband has elastic properties.
